(19) United States
(12) Patent Application Publication
(10) Pub. No.: US 2012/0098705 A1
(43) Pub. Date: Apr. 26, 2012

(54) USE OF HEURISTIC DATA FOR SENDING MESSAGE FROM MOBILE COMPUTING DEVICE

(75) Inventors: Karl Yost, Mountain View, CA (US); Gadi Naveh, Sunnyvale, CA (US)

(73) Assignee: Palm, Inc.

(21) Appl. No.: 12/910,666

(22) Filed: Oct. 22, 2010

(51) Int. Cl. G01S 3/02

(52) U.S. Cl. 342/451; 342/450

(57) ABSTRACT

A mobile computing device comprises a wireless transceiver and a processing circuit. The processing circuit is configured to store a data set for a predetermined location, the data set comprising location data and a location name. The processing circuit is further configured to compare a current location to the location data, to compare an updated location to the location data at a time calculated based on heuristic data, and to generate a notification message based on the mobile computing device arriving proximate to the predetermined location.

### BACKGROUND

Some mobile computing devices provide location-based services to a user. For example, a mobile computing device may use a navigation application to provide directions from the user's current location to a desired destination. A location-determining circuit or system may be used to periodically determine the location of the mobile computing device.

Mobile computing devices may also have wireless transceivers configured to communicate with various types of wireless devices over various types of wireless networks.

### BRIEF DESCRIPTION OF THE DRAWINGS

FIG. 1 is a perspective view of a mobile computing device according to an exemplary embodiment.

FIG. 2 is a front view of the mobile computing device of FIG. 1 in an extended configuration according to an exemplary embodiment.

FIG. 3 is a back view of the mobile computing device of FIG. 1 in an extended configuration according to an exemplary embodiment.

FIG. 4 is a side view of the mobile computing device of FIG. 1 in an extended configuration according to an exemplary embodiment

FIG. 5 is a block diagram of the mobile computing device of FIG. 1 according to an exemplary embodiment.

FIG. 6 is a flowchart of a learning algorithm, according to an exemplary embodiment.

FIG. 7 is a flowchart of an operating algorithm, according to an exemplary embodiment.

FIG. 8 is a flowchart of an operating algorithm, according to an exemplary embodiment.

FIG. 9 is a flowchart of an operating algorithm, according to an exemplary embodiment.

FIG. 10 is a flowchart of an operating algorithm, according to an exemplary embodiment.

FIG. 11 is an exemplary data structure.

FIG. 12 is an exemplary data structure.

FIG. 13 is a flowchart of an operating algorithm, according to another exemplary embodiment.

FIG. 14 is a flowchart of an operating algorithm, according to another exemplary embodiment.

FIG. 15 is a flowchart of an operating algorithm, according to another exemplary embodiment.

FIG. 16 is a flowchart of an operating algorithm, according to another exemplary embodiment.

### DETAILED DESCRIPTION

Some embodiments described herein may use heuristic data to determine when to check if a mobile computing device is at a predetermined destination. Some embodiments described herein may determine a probability of when a mobile computing device will arrive at a location. Some embodiments described herein may capture the arrival or departure of a mobile computing device at a location without excessively draining the battery, such as during times when a user is not moving.

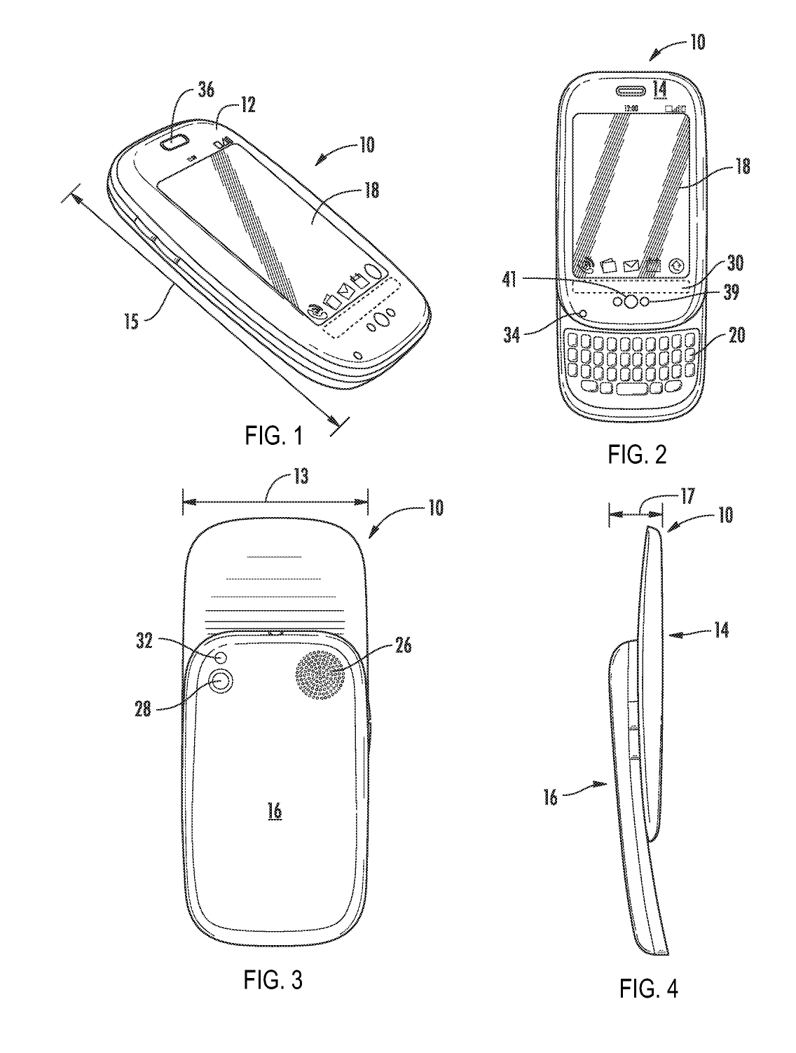

Referring to FIGS. 1-4, a mobile device 10 is shown. The teachings herein can be applied to device 10 or to other electronic devices (e.g., a desktop computer), mobile or portable computing devices (e.g., a laptop computer) or handheld computing devices, such as a personal digital assistant (PDA), smartphone, mobile telephone, personal navigation device, etc. According to one embodiment, device 10 may be a smartphone, which is a combination mobile telephone and handheld computer having PDA functionality. PDA functionality can comprise one or more of personal information management (e.g., including personal data applications such as email, calendar, contacts, etc.), database functions, word processing, spreadsheets, voice memo recording, Global Positioning System (GPS) functionality, etc. Device 10 may be configured to synchronize personal information from these applications with a computer (e.g., a desktop, laptop, server, etc.). Device 10 may be further configured to receive and operate additional applications provided to device 10 after manufacture, e.g., via wired or wireless download, SecureDigital card, etc.

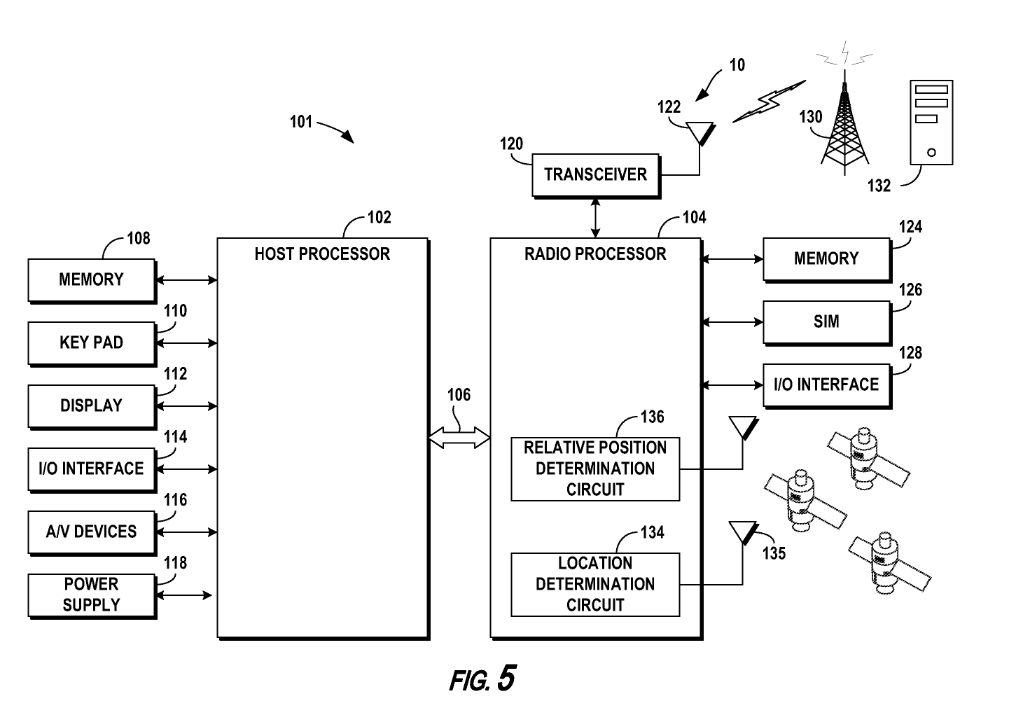

As shown in FIGS. 1-4, device 10 includes a housing 12 and a front 14 and a back 16. Device 10 further comprises a display 18 and a user input device 20 (e.g., a QWERTY keyboard, buttons, touch screen, speech recognition engine, etc.). Display 18 may comprise a touch screen display in order to provide user input to a processing circuit 101 (see FIG. 4) to control functions, such as to select options displayed on display 18, enter text input to device 10, or enter other types of input. Display 18 also provides images (see, e.g., FIG. 5) that are displayed and may be viewed by users of device 10. User input device 20 can provide similar inputs as those of touch screen display 18. An input button 40 may be provided on front 14 and may be configured to perform pre-programmed functions. Device 10 can further comprise a speaker 26, a stylus (not shown) to assist the user in making selections on display 18, a camera 28, a camera flash 32, a microphone 34, and an earpiece 36. Display 18 may comprise a capacitive touch screen, a mutual capacitance touch screen, a self capacitance touch screen, a resistive touch screen, a touch screen using cameras and light such as a surface multi-touch screen, proximity sensors, or other touch screen technologies, and so on. Display 18 may be configured to receive inputs from finger touches at a plurality of locations on display 18 at the same time. Display 18 may be configured to receive a finger swipe or other directional input, which may be interpreted by a processing circuit to control certain functions distinct from a single touch input. Further, a gesture area 30 may be provided adjacent (e.g., below, above, to a side, etc.) or be incorporated into display 18 to receive various gestures as inputs, including taps, swipes, drags, flips, pinches, and so on. One or more indicator areas 38 (e.g., lights, etc.) may be provided to indicate that a gesture has been received from a user.

According to an exemplary embodiment, housing 12 is configured to hold a screen such as display 18 in a fixed relationship above a user input device such as user input device 20 in a substantially parallel or same plane. This fixed relationship excludes a hinged or movable relationship between the screen and the user input device (e.g., a plurality of keys) in the fixed embodiment.

Device 10 may be a handheld computer, which is a computer small enough to be carried in a hand of a user, comprising such devices as typical mobile telephones and personal digital assistants, but excluding typical laptop computers and tablet PCs. The various input devices and other components of device 10 as described below may be positioned anywhere on device 10 (e.g., the front surface shown in FIG. 2, the rear surface shown in FIG. 3, the side surfaces as shown in FIG. 4, etc.). Furthermore, various components such as a keyboard etc. may be retractable to slide in and out from a portion of device 10 to be revealed along any of the sides of device 10, etc. For example, as shown in FIGS. 2-4, front 14 may be slidably adjustable relative to back 16 to reveal input device 20, such that in a retracted configuration (see FIG. 1) input device 20 is not visible, and in an extended configuration (see FIGS. 2-4) input device 20 is visible.

According to various exemplary embodiments, housing 12 may be any size, shape, and have a variety of length, width, thickness, and volume dimensions. For example, width 13 may be no more than about 200 millimeters (mm), 100 mm, 85 mm, or 65 mm, or alternatively, at least about 30 mm, 50 mm, or 55 mm. Length 15 may be no more than about 200 mm, 150 mm, 135 mm, or 125 mm, or alternatively, at least about 70 mm or 100 mm. Thickness 17 may be no more than about 150 mm, 50 mm, 25 mm, or 15 mm, or alternatively, at least about 10 mm, 15 mm, or 50 mm. The volume of housing 12 may be no more than about 2500 cubic centimeters (cc) or 1500 cc, or alternatively, at least about 1000 cc or 600 cc.

Device 10 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, etc.

In addition to voice communications functionality, device 10 may be configured to provide data communications functionality in accordance with different types of cellular radiotelephone systems. Examples of cellular radiotelephone systems offering data communications services may include, but are not limited to, GSM with General Packet Radio Service (GPRS) systems (GSM/GPRS), CDMA/1 xRTT systems, Enhanced Data Rates for Global Evolution (EDGE) systems, Evolution Data Only or Evolution Data Optimized (EV-DO) systems, Long Term Evolution (LTE) systems, etc.

Device 10 may be configured to provide voice and/or data communications functionality in accordance with different types of wireless network systems. Examples of wireless network systems may further include a wireless local area network (WLAN) system, wireless metropolitan area network (WMAN) system, wireless wide area network (WWAN) system, and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth.

Device 10 may be configured to perform data communications in accordance with different types of shorter range wireless systems, such as a wireless personal area network (PAN) system. One example of a suitable wireless PAN system offering data communication services may include a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth.

As shown in the embodiment of FIG. 5, device 10 may comprise a processing circuit having a dual- or multi-processor architecture including a host processor 102 and a radio processor 104 (e.g., a base band processor). Host processor 102 and radio processor 104 may be distinct, separate or different chips, integrated circuit packages, parts or components. The host processor 102 and the radio processor 104 may be configured to communicate with each other using interfaces 106 such as one or more universal serial bus (USB) interfaces, micro-USB interfaces, universal asynchronous receiver-transmitter (UART) interfaces, general purpose input/output (GPIO) interfaces, control/status lines, control/data lines, shared memory, and so forth. Alternatively, the processing circuit may comprise one processor, more than two processors, and/or other analog and/or digital circuit components configured to or programmed to operate as described herein with respect to the various embodiments.

The host processor 102 may be responsible for executing various software programs such as application programs and system programs to provide computing and processing operations for device 10. The radio processor 104 may be responsible for performing various voice and data communications operations for device 10 such as transmitting and receiving voice and data information over one or more wireless communications channels. Although embodiments of the dual processor architecture may be described as comprising the host processor 102 and the radio processor 104 for purposes of illustration, the dual processor architecture of device 10 may comprise additional processors, may be implemented as a dual- or multi-core chip with both host processor 102 and radio processor 104 as distinct processing components fabricated on a single chip, etc.

In various embodiments, the host processor 102 may be implemented as a host central processing unit (CPU) using any suitable processor or an algorithm device, such as a general purpose processor. The host processor 102 may comprise, or be implemented as, a chip multiprocessor (CMP), dedicated processor, embedded processor, media processor, input/output (I/O) processor, co-processor, a field programmable gate array (FPGA), a programmable an algorithm device (PLD), or other processing device in alternative embodiments. In an exemplary embodiment, host processor 102 is an OMAP2, such as an OMAP2431 processor, manufactured by Texas Instruments, Inc.

The host processor 102 may be configured to provide processing or computing resources to device 10. For example, the host processor 102 may be responsible for executing various software programs such as application programs and system programs to provide computing and processing operations for device 10. Examples of application programs may include, for example, a telephone application, voicemail application, e-mail application, instant message (IM) application, short message service (SMS) application, multimedia message service (MMS) application, web browser application, personal information manager (PIM) application, contact management application, calendar application, scheduling application, task management application, word processing application, spreadsheet application, database application, video player application, audio player application, multimedia player application, digital camera application, video camera application, media management application, a gaming application, and so forth. The application software may provide a graphical user interface (GUI) to communicate information between device 10 and a user.

System programs assist in the running of a computer system. System programs may be directly responsible for controlling, integrating, and managing the individual hardware components of the computer system. Examples of system programs may include, for example, an operating system (OS), device drivers, programming tools, utility programs, software libraries, an application programming interface (API), graphical user interface (GUI), and so forth. Device 10 may utilize any suitable OS in accordance with the described embodiments such as a Palm WebOS, Palm OS®, Palm OS® Cobalt, Microsoft® Windows OS, Microsoft Windows® CE, Microsoft Pocket PC, Microsoft Mobile, Symbian OS™, Embedix OS, Linux, Binary Run-time Environment for Wireless (BREW) OS, JavaOS, a Wireless Application Protocol (WAP) OS, and so forth.

Device 10 may comprise a memory 108 coupled to the host processor 102. In various embodiments, the memory 108 may be configured to store one or more software programs to be executed by the host processor 102. The memory 108 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), or any other type of media suitable for storing information.

Although the memory 108 may be shown as being separate from the host processor 102 for purposes of illustration, in various embodiments some portion or the entire memory 108 may be included on the same integrated circuit as the host processor 102. Alternatively, some portion or the entire memory 108 may be disposed on an integrated circuit or other medium (e.g., hard disk drive) external to the integrated circuit of host processor 102. In various embodiments, device 10 may comprise an expansion slot to support a multimedia and/or memory card, for example.

Device 10 may comprise a user input device 110 coupled to the host processor 102. The user input device 110 may comprise, for example, a QWERTY key layout and an integrated number dial pad. Device 10 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad, an alphanumeric keypad, and so forth.

The host processor 102 may be coupled to a display 112. The display 112 may comprise any suitable visual interface for displaying content to a user of device 10. For example, the display 112 may be implemented by a liquid crystal display (LCD) such as a touch-sensitive color (e.g., 16-bit color) thin-film transistor (TFT) LCD screen. In some embodiments, the touch-sensitive LCD may be used with a stylus and/or a handwriting recognizer program.

Device 10 may comprise an input/output (I/O) interface 114 coupled to the host processor 102. The I/O interface 114 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a local personal computer (PC). In various implementations, device 10 may be configured to transfer and/or synchronize information with the local computer system.

The host processor 102 may be coupled to various audio/video (A/V) devices 116 that support A/V capability of device 10. Examples of A/V devices 116 may include, for example, a microphone, one or more speakers, an audio port to connect an audio headset, an audio coder/decoder (codec), an audio player, a digital camera, a video camera, a video codec, a video player, and so forth.

The host processor 102 may be coupled to a power supply 118 configured to supply and manage power to the elements of device 10. In various embodiments, the power supply 118 may be implemented by a rechargeable battery, such as a removable and rechargeable lithium ion battery to provide direct current (DC) power, and/or an alternating current (AC) adapter to draw power from a standard AC main power supply.

As mentioned above, the radio processor 104 may perform voice and/or data communication operations for device 10. For example, the radio processor 104 may be configured to communicate voice information and/or data information over one or more assigned frequency bands of a wireless communication channel. In various embodiments, the radio processor 104 may be implemented as a communications processor using any suitable processor or an algorithm device, such as a modem processor or base band processor. Although some embodiments may be described with the radio processor 104 implemented as a modem processor or base band processor by way of example, it may be appreciated that the embodiments are not limited in this context. For example, the radio processor 104 may comprise, or be implemented as, a digital signal processor (DSP), media access control (MAC) processor, or any other type of communications processor in accordance with the described embodiments. Radio processor 104 may be any of a plurality of modems manufactured by Qualcomm, Inc. or other manufacturers.

In various embodiments, the radio processor 104 may perform analog and/or digital base band operations for device 10. For example, the radio processor 104 may perform digital-to-analog conversion (DAC), analog-to-digital conversion (ADC), modulation, demodulation, encoding, decoding, encryption, decryption, and so forth.

Device 10 may comprise a transceiver module 120 coupled to the radio processor 104. The transceiver module 120 may comprise one or more transceivers configured to communicate using different types of wireless access points using different protocols, communication ranges, operating power requirements, RF sub-bands, information types (e.g., voice or data), use scenarios, applications, and so forth. In various embodiments, the transceiver module 120 may comprise one or more transceivers configured to support voice communication for a cellular radiotelephone system such as a GSM, UMTS, CDMA, and/or LTE system. The transceiver module 120 also may comprise one or more transceivers configured to perform data communications in accordance with one or more wireless communications protocols such as WWAN protocols (e.g., GSM/GPRS protocols, CDMA/1xRTT protocols, EDGE protocols, EV-DO protocols, EV-DV protocols, HSDPA protocols, etc.), WLAN protocols (e.g., IEEE 802.11a/b/g/n, IEEE 802.16, IEEE 802.20, etc.), PAN protocols, Infrared protocols, Bluetooth protocols, EMI protocols including passive or active RFID protocols, and so forth.

The transceiver module 120 may be implemented using one or more chips as desired for a given implementation. Although the transceiver module 120 may be shown as being separate from and external to the radio processor 104 for purposes of illustration, in various embodiments some portion or the entire transceiver module 120 may be included on the same integrated circuit as the radio processor 104.

Device 10 may comprise an antenna system 122 for transmitting and/or receiving electrical signals. As shown, the antenna system 122 may be coupled to the radio processor 104 through the transceiver module 120. The antenna system 122 may comprise or be implemented as one or more internal antennas and/or external antennas.

Device 10 may comprise a memory 124 coupled to the radio processor 104. The memory 124 may be implemented using one or more types of machine-readable or computer-readable media capable of storing data such as volatile memory or non-volatile memory, removable or non-removable memory, erasable or non-erasable memory, writeable or re-writeable memory, etc. The memory 124 may comprise, for example, flash memory and secure digital (SD) RAM. Although the memory 124 may be shown as being separate from and external to the radio processor 104 for purposes of illustration, in various embodiments some portion or the entire memory 124 may be included on the same integrated circuit as the radio processor 104.

Device 10 may comprise a subscriber identity module (SIM) 126 coupled to the radio processor 104. The SIM 126 may comprise, for example, a removable or non-removable smart card configured to encrypt voice and data transmissions and to store user-specific data for allowing a voice or data communications network to identify and authenticate the user. The SIM 126 also may store data such as personal settings specific to the user.

Device 10 may comprise an I/O interface 128 coupled to the radio processor 104. The I/O interface 128 may comprise one or more I/O devices to enable wired (e.g., serial, cable, etc.) and/or wireless (e.g., WiFi, short range, etc.) communication between device 10 and one or more external computer systems.

In various embodiments, device 10 may comprise location or position determination capabilities. Device 10 may employ one or more location determination techniques including, for example, Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFLT) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc.

Device 10 may be configured to operate in one or more location determination modes including, for example, a standalone mode, a mobile station (MS) assisted mode, and/or a MS-based mode. In a standalone mode, such as a standalone GPS mode, device 10 may be configured to determine its position without receiving wireless navigation data from the network, though it may receive certain types of position assist data, such as almanac, ephemeris, and coarse data. In a standalone mode, device 10 may comprise a local location determination circuit 134 (e.g., a GPS receiver) which may be integrated within housing 12 (FIG. 1) configured to receive satellite data via an antenna 135 and to calculate a position fix. Local location determination circuit may alternatively comprise a GPS receiver in a second housing separate from housing 12 but in the vicinity of device 10 and configured to communicate with device 10 wirelessly (e.g., via a PAN, such as Bluetooth). When operating in an MS-assisted mode or an MS-based mode, however, device 10 may be configured to communicate over a radio access network 130 (e.g., UMTS radio access network) with a remote computer 132 (e.g., a location determination entity (PDE), a location proxy server (LPS) and/or a mobile positioning center (MPC), etc.). Remote computer 132 may in alternative embodiments comprise any server computer used for any of a variety of functions (e.g., a shared, scaleable computing resource such as a cloud computing environment, or one or more other server computers).

In an MS-assisted mode, such as an MS-assisted AGPS mode, the remote computer 132 may be configured to determine the position of the mobile computing device and provide wireless data comprising a position fix. In an MS-based mode, such as an MS-based AGPS mode, device 10 may be configured to determine its position using acquisition data or other wireless data from the remote computer 132. The acquisition data may be provided periodically. In various implementations, device 10 and the remote computer 132 may be configured to communicate according to a suitable MS-PDE protocol (e.g., MS-LPS or MS-MPC protocol) such as the TIA/EIA standard IS-801 message protocol for MS-assisted and MS-based sessions in a CDMA radiotelephone system.

When assisting the mobile computing device 10, the remote computer 132 may handle various processing operations and also may provide information to aid location determination. Examples of position assist data may include satellite-based measurements, terrestrial-based measurements, and/or system-based measurements such as satellite almanac information, GPS code phase measurements, ionospheric data, ephemeris data, time correction information, altitude estimates, timing offsets, forward/reverse link calibration, coarse data, and so forth.

In various implementations, the position assist data provided by the remote computer 132 may improve the speed of satellite acquisition and the probability of a position fix by concentrating the search for a GPS signal and/or may improve the accuracy of location determination. Each position fix or series of position fixes may be available at device 10 and/or at the remote computer 132 depending on the location determination mode. In some cases, data calls may be made and position assist data may be sent to device 10 from the remote computer 132 for every position fix (e.g., in an ad hoc mode). In other cases, data calls may be made and position assist data may be sent periodically and/or as needed.

In various embodiments, device 10 may comprise dedicated hardware circuits or structures, or a combination of dedicated hardware programmed with code, to support location determination. For example, the transceiver module 120 and the antenna system 122 may comprise GPS receiver or transceiver hardware and one or more associated antennas coupled to the radio processor 104 to support location determination.

The host processor 102 may comprise and/or implement at least one LBS (location-based service) application. In general, the LBS application may comprise any type of client application executed by the host processor 102, such as a GPS application, configured to communicate location requests (e.g., requests for position fixes) and location responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (POI) such as restaurants, hotels, landmarks, and entertainment venues, and other types of LBS services in accordance with the described embodiments.

The LBS application may be configured to send a location request in response to receiving input from device 10 or from a source external to device 10. For example, the user of device 10 may interact with a data input device to command the LBS application to send a location request. The LBS application also may send a location request in response to receiving input from an external network element or computing device that is attempting to locate the user of device 10. In some cases, the LBS application also may be configured to automatically, periodically, and/or autonomously send location requests.

Although other applications may operate without regard to the location of device 10, in various embodiments, the LBS application may request and receive position information to enhance the functionality of one or more of the other applications. For example, position information may be provided in conjunction with a messaging application to locate the sender or recipient of a message. Position information may be provided to a web browser application to generate directions to a location associated with a particular website. Positioning information may be provided to a personal management application to generate location-based alerts and/or directions to a meeting place.

The radio processor 104 may be configured to receive location requests from an LBS API handler on host processor 102 and may forward location responses to the LBS API handler for delivery to the LBS application through the LBS API. Radio processor 104 may be configured to communicate securely over a network with remote computer 132 (e.g., PDE, LPS or MPC) configured to provide authentication and authorization services and/or a variety of geo-services. For example, radio processor 104 may be configured to communicate with a PDE configured to verify privacy for location requests, allow authorized access to a location server, and provide various location server services. Radio processor 104 also may be configured to communicate with a PDE to request and receive geo-service information. Examples of geo-service information may include mapping information, routing information, geo-coding and reverse geo-coding information for addresses and coordinates, POI information, and so forth.

Radio processor 104 may be configured to invoke a position fix by configuring a position engine and requesting a position fix. For example, a position engine interface on radio processor 104 may set configuration parameters that control the location determination process. Examples of configuration parameters may include, without limitation, location determination mode (e.g., standalone, MS-assisted, MS-based), actual or estimated number of position fixes (e.g., single position fix, series of position fixes, request position assist data without a position fix), time interval between position fixes, Quality of Service (QoS) values, optimization parameters (e.g., optimized for speed, accuracy, or payload), PDE address (e.g., IP address and port number of LPS or MPC), etc.

Radio processor 104 also may set request/response parameters to request and return various types of position information. Examples of request/response parameters may include current location, latitude, longitude, altitude, heading, vector information such as horizontal and vertical velocity, sector-based position location, position fix method, level of accuracy, time offset, position uncertainty, device orientation, client initialization and registration, and so forth.

The radio processor 104 may comprise or implement a position engine such as a GPS engine. In various embodiments, the position engine may be configured to provide location determination capabilities for device 10. In some embodiments, the position engine may be implemented as software operating in conjunction with hardware (e.g., GPS receiver hardware) allowing device 10 to receive and process GPS satellites signals for location determination. In one embodiment, the position engine may be implemented as a QUALCOMM® gpsOne® engine.

In various implementations, the position engine may employ one or more location determination techniques such as GPS, CGI, CGI+TA, EFLT, TDOA, AOA, AFLT, OTDOA, EOTD, AGPS, GPS/AGPS, hybrid techniques, and so forth. The position engine also may be configured to operate in one or more location determination modes including a standalone mode, an MS-assisted mode, and an MS-based mode. The determined position information generated and/or obtained by the position engine generally may comprise any type of information associated with the location of device 10. Examples of position information may include, without limitation, current location, latitude, longitude, altitude, heading information, vector information such as horizontal and vertical velocity, sector-based position location, position fix information, position uncertainty, device orientation, and so forth.

In various embodiments, device 10 may be used in connection with a variety of applications that require determination of the location of device 10. Various navigation and mapping applications may be utilized to provide various types of data and information to users, including driving directions, map information, point of interest (POI) information, and so on. One such application may be a family or friend/buddy connect application which may be configured to determine that a mobile device arrives at or departs from a predetermined location (e.g., work, school, friend's house, shopping mall, etc.) and to generate a message and send the message to one or more other computing devices to notify the other devices that the first device has arrived or departed. The application may be configured to store message addresses (e.g., phone numbers for text, voice, or MMS messages, e-mail addresses, etc.) for one or more other people in a family or buddy list and to further store one or more locations that will trigger the generation and sending of a message to the one or more other people's computing devices or on-line accounts (e.g., social networking account such as a Facebook account, e-mail account, instant message account, etc.). Such an application operates using periodic location data from location determination circuit 134, in order to determine when the device has arrived proximate to, or departed from a predetermined location.

A location determining circuit or system such as location determining circuit 134 (see FIG. 5) may periodically or continuously determine or track (e.g., obtain, request or determine a position fix, update a location, etc.) the location of device 10 at a standard rate or period (e.g., every second, twice per second, etc.) on a continuous, ongoing basis. Utilizing a location determining system in such a manner, however, typically requires significant power. Should a device rely on a power source such as a battery (e.g., as in the case with typical mobile phones, smart phones, and other mobile devices), the available usage time of the device may be significantly decreased because of the power requirements of the location determining system.

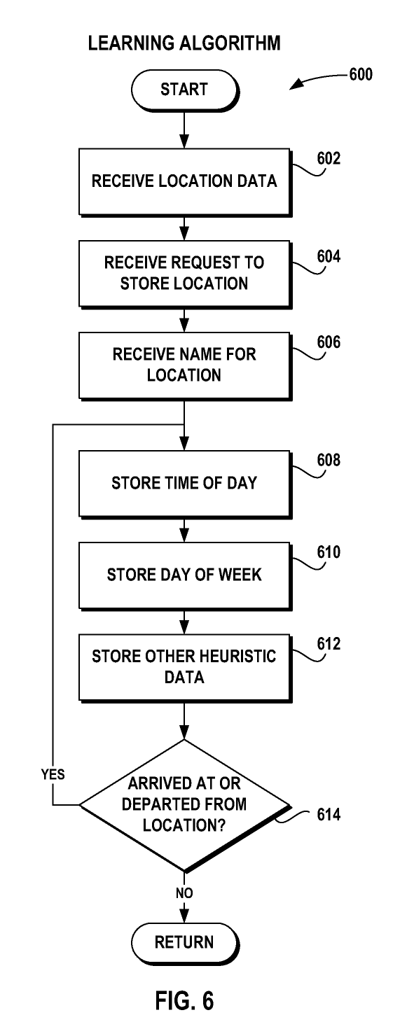

Referring now to FIG. 6, a flowchart of a learning algorithm will be described, according to an exemplary embodiment. Algorithm 600 is operable to collect data regarding predetermined or primary locations that a device 10 typically arrives and/or departs from on a regular basis. People often follow a same or similar day-to-day, or week-to-week routine. From a time/location perspective, device 10 can be expected to arrive and depart from primary locations with some regularity or consistency. By tracking arrival/departure times of preset or predetermined locations, device 10 can, over time, learn the habits of a user and increase the frequency that it checks for arrivals/departures during particular time windows. During times which historically do not represent a change in location, device 10 can decrease the frequency of location checks. As a results, device 10 is able to accurately capture arrival/departure of a person at one or more locations without excessively draining the battery during times when the user is not moving.

At block 602, a processing circuit of device 10 is configured to receive location data. Location data may be received using any of the processes or technologies described hereinabove. In one embodiment, only wireless access point location data (e.g., cellular base station, Wi-Fi transceiver, Wi-MAX transceiver, Bluetooth transceiver, etc.) is used, to avoid the power drain needed to generate latitude/longitude data with a GPS receiver. In other embodiments, latitude/longitude data may be used instead of or in addition to wireless access point location data. In block 602, the location data represents a current location of device 10.

Circuit 101 may be configured to send IDs received from wireless access points to a remote server 132 configured to operate a database of wireless access point identifiers and corresponding location data. Server 132 may be configured to receive the IDs, look up one or more wireless access point locations, and return the wireless access point identifiers to circuit 101. For example, server 132 may be configured to operate a map application made by Google, Inc., Mountain View, Calif., which may store cellular IDs for cellular towers mapped to approximate locations. Alternatively, circuit 101 may identify wireless access points with reference to a local database stored on device 10. In some circumstances, circuit 101 may be configured to receive wireless access point locations from a user via a user input device.

At block 604, a request or command to store the location is received. This request may be received from a user input device when a user determines they are at a location of interest (e.g., work, home, school, etc.) and tags or geosenses that location. Alternatively, the request or command may be received from another application or process operating on circuit 101 which determines that the device is at a primary location. For example, the process may conclude that a device that does not move from midnight until 5 AM over one or more nights is at a “home” location, and therefore command circuit 101 to store the current location as a home location. Similarly, a process may conclude that a device that does not move from 8 AM until 2 PM, but then moves about from 2 PM until 5 PM over one more days is at a “school” location, whereas a device that does not move from 8 AM until 5 PM is at a “work” location. Other processes are contemplated. The location data may be stored as a new record or to add to or update an existing record for a location of interest.

At block 606, a name for the location may be received. The name may be received from a user (e.g., “Bob's house”, “work”, etc.), or the name may be deduced by another process based on location, time of day, and/or day of week data (e.g., “home,” “school,” or “work,” as described above). The name may be stored along with the location received in block 602 as a data set, which may be a set of more than one data associated with each other.

Additional heuristic data, such as time of day (block 608), day of week (block 610) or other heuristic data (block 612), cell tower(s), wifi networks, etc. may be received and stored as part of the data set.

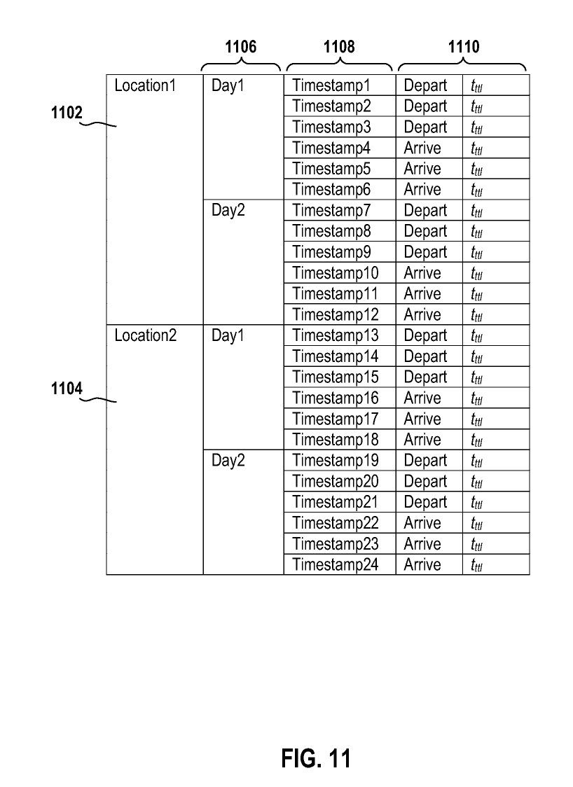

Referring to FIG. 11, an exemplary data structure is shown. Predetermined locations 1102, 1104, each have day of the week (and/or date) data 1106, each day of the week structure having timestamps 1108 of departures and arrivals, along with an associated age 1110 of the timestamp. To conserve data space and to adjust to changes in lifestyle/habits of the user, only recent history (e.g., more recent than tₜₜₗ) may be retained and data older than the predetermined purge time tₜₜₗ may be deleted, purged, or archived to remote storage.

Block 614 indicates an exemplary operation in which circuit 101 determines whether device 10 has arrived at or departed from a predetermined location which has been previously stored based on historical operation as a data set. If so, blocks 608-612 may be repeated to capture, update or add to the heuristic data in the data set. If not, the algorithm may return to other processing.

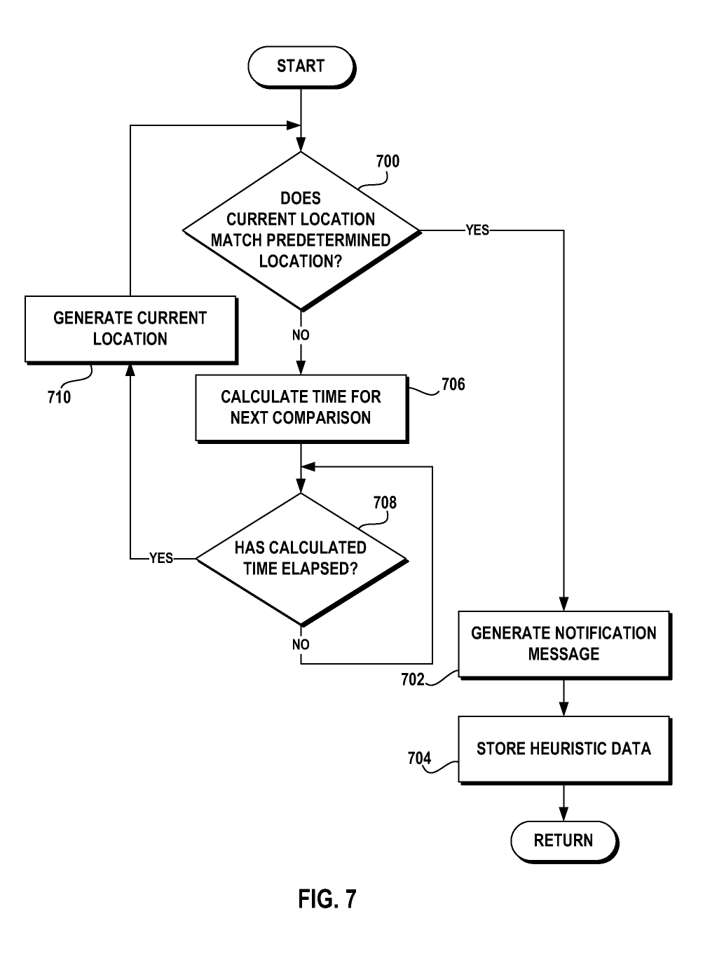

Referring now to FIG. 7, a flowchart of an operating algorithm will be described, according to an exemplary embodiment. In one embodiment, processing circuit 101 may be configured to operate a distinct software application or service configured to periodically check a location of device 10 and determine whether device 10 has arrived at or departed from a location. In an alternative embodiment, one or more of the blocks described herein may operate as part of an operating system of device 10 instead of a distinct application. At a block 700, a current location of device 10 is compared to a predetermined location, such as one stored or learned using one of the algorithms of FIG. 6. For example, a current cellular base station ID detected by radio processor 104 may be compared to a cellular base station ID associated with the predetermined location. As another example, a latitude/longitude generated by location determination circuit 134 may be compared to a latitude/longitude of the predetermined location to determine if the two values are within a predetermined distance of each other (e.g., less than about 10 meters, less than about 100 meters, less than about 1 kilometer, etc.). If a match is identified, at a block 702, an automated action can be taken. As an example, a notification message could be generated (e.g., by creating a text message, SMS message, HTML message, phone call, etc.). Device 10 may then be configured to send the message over a wireless communication link. At a block 704, circuit 101 is configured to store heuristic data, such as that described above with respect to 608, 610 and 612, to a data set or data structure, in order to further improve the learning process.

If no match is identified in block 700, at block 706 circuit 101 is configured to calculate a time for the next comparison and/or location generation for comparison. Heuristic data may be variables in the calculation. Heuristics may comprise experience-based techniques that help in problem solving, learning and discovery, and heuristic data may comprise any data used by such techniques. Heuristic techniques may be designed to solve a problem in a manner that deemphasize the need to be proven to be correct, but which usually produces a good solution or solves a simpler problem that contains or intersects with the solution of the more complex problem. Heuristic data may comprise a time of day associated with the predetermined location, wherein the processing circuit is configured to generate the time of day based on a prior occurrence of the mobile computing device being present at the predetermined location. Heuristic data may comprise a plurality of arrival times of day and a plurality of departure times of day associated with the predetermined location. Heuristic data may further comprise a day of the week, wherein the processing circuit is configured to generate the day of the week based on a prior occurrence of the mobile computing device being present at the predetermined location. Heuristic data may comprise how old certain other heuristic data is. Data not considered to be heuristic may also be used in the calculation at block 706. For example, a calculation of distance from the current location of device 10 to any stored predetermined location(s) may be used in the calculation.

At block 708, a timer is set to determine whether the period of time for the next comparison (e.g., in a periodic or continuous series of comparisons) has passed. If it has, a new or updated current location is generated at block 710 and then compared to one or more predetermined locations at block 700.

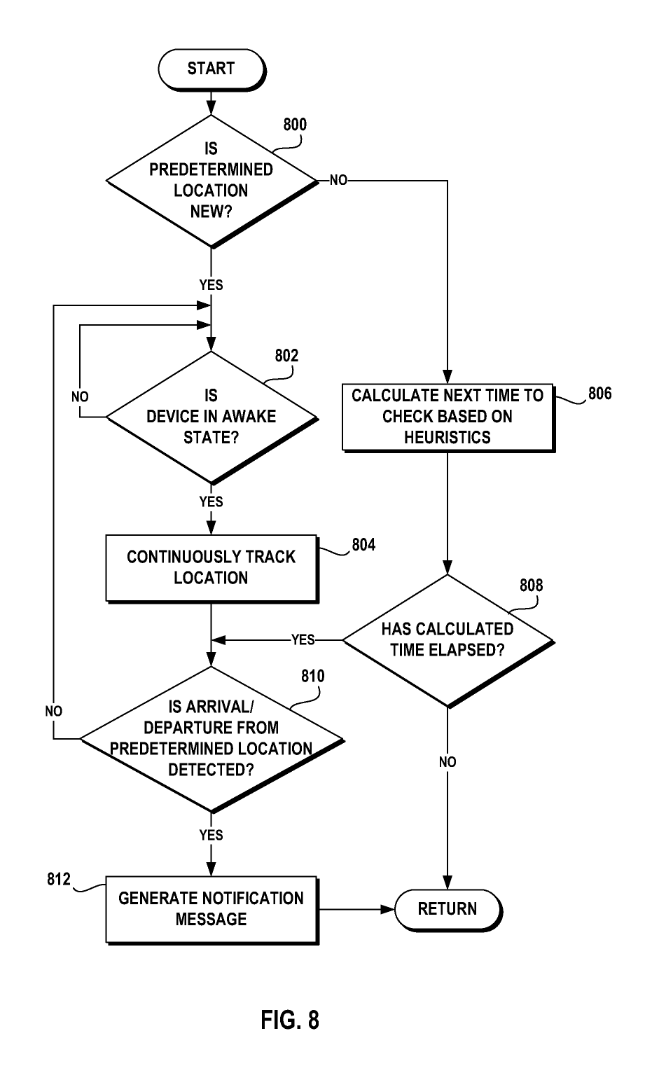

Referring now to FIG. 8, a flowchart of an operating algorithm will be described, according to an exemplary embodiment. Each predetermined location may have a history associated with it, stored in a data set or data structure. The history will track day and time that a device arrives or departs from a specified location (e.g., which may support Geofencing, a virtual perimeter for a location). In the embodiment of FIG. 8, the algorithm for calculating the next time to check location may depend on whether a location is a new location or an old location. For a new location, there may be periodic checks to see if a person has arrived or left the location. After a period of time t_{old}, the location is no longer considered a new location. At this point in time, a history of the user's behavior will be established, and a different algorithm can be run based on knowledge of when a user commonly arrives or departs from that location.

At block 800, circuit 101 is configured to determine whether the predetermined location is new or old, which may be done in one embodiment by determining how long the predetermined location has been stored or known by circuit 101 and determining whether that time is less than a predetermined threshold (e.g., less than one week, less than one month, etc.). If the location is new, at block 802, it is determined whether device 10 is in an awake state or full-powered state (e.g., which may be defined as having the screen on, being in the middle of a phone call, or other definitions of an awake state). If so, at block 804, continuous tracking of location is enabled. The continuous tracking may generate location data less than every 2 seconds, less than every 1 minute, less than every hour, etc. If the device is in a low power consumption (sleep state), location will not be tracked continuously until the device is in an awake state.

If the predetermined location is not new, at a block 806, a time to next check may be calculated based on heuristics. Then, when it is time to check (block 808), arrival to or departure from the predetermined location can be detected (block 810), and a message generated (block 812) as described previously. An exemplary algorithm is shown below:

If {Location is new} (t< t_{old})

Check for location anytime device is in ‘awake state’
(device is awake, screen on)

Else if {Location is established} (t> t_{old})

Check for location based on heuristics.

End if

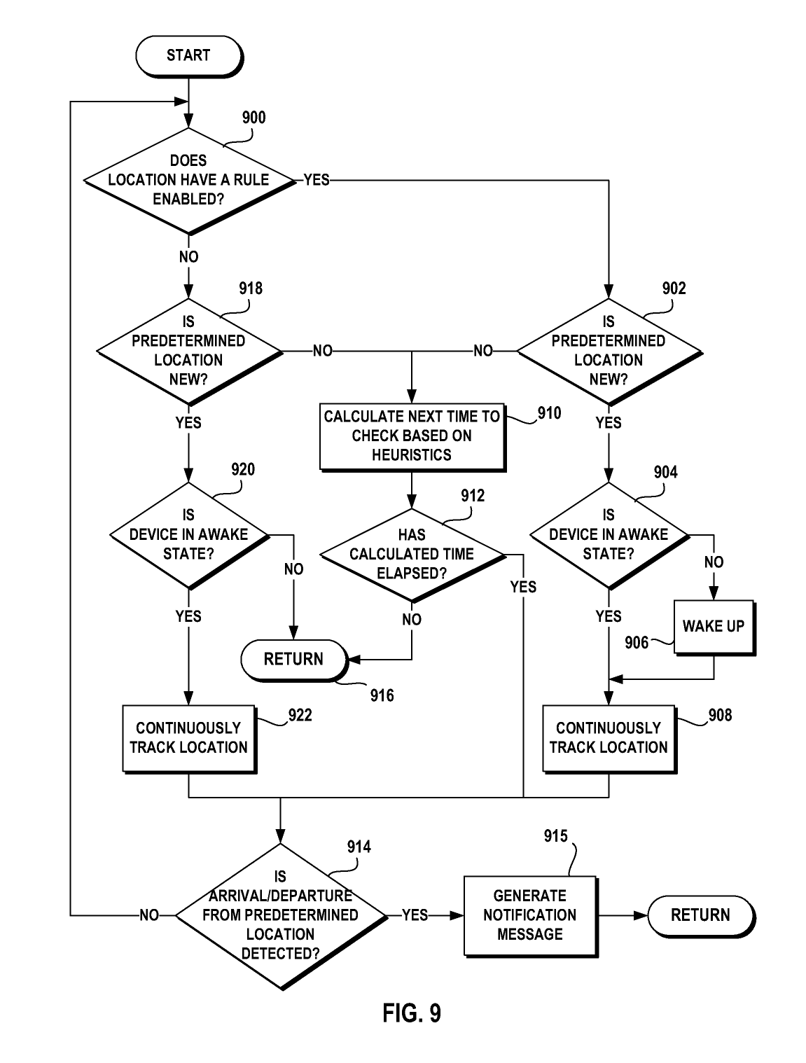

Referring now to FIG. 9, a flowchart of an operating algorithm will be described, according to an exemplary embodiment. In this embodiment, the algorithm may be different depending on whether the predetermined location has a rule associated with it or not. For example, the device can be forced into an awake state for a new location if the location has a rule associated with it, whereas if the location does not have a rule associated with it, the device will remain in a sleep state to conserver power. A rule can trigger a predetermined action. The action may be but is not limited to a notification (email, SMS, MMS, etc.), a reminder, an alarm, changing network preference (e.g. from cellular to wifi), etc.

At a block 900, circuit 101 determines whether any of the predetermined locations has a rule associated with it and/or whether the rule is enabled or disabled (e.g., by a user). If so, at a block 902 circuit 101 determined whether the predetermined location new. If so, circuit 101 determines whether device 10 is in an awake state (block 904). If so, the device wakes up (block 906) so that location can be continuously tracked (block 908). If the location is not new, at block 910 circuit 101 calculates the next time to check if device 10 is arriving proximate to or departing from any of the predetermined locations, for example based on heuristic and/or non-heuristic data. At block 912, when it is time to check, the check is executed at block 914 and notification message generated at block 915 if needed. If not time to check, the algorithm returns (block 916) for further processing of this or other algorithms.

Returning to block 900, if the location does not have a rule created, active, or enabled, at a block 918 circuit 101 determines if the predetermined location is new? If so, circuit 101 determines if the device is in an awake state (block 920) before continuously tracking location (block 922). If not awake, the algorithm returns for further processing. The device is not awakened in this mode, in order to conserve power. If a rule is later added, then the YES branch of block 900 can be followed. An exemplary algorithm is shown below:

If {Location has a rule enabled}

If {Location is a new location}

Check for location periodically (App permitted to wake up
device)
**Note: This code path will drain the battery the fastest

Else

Check for location based on heuristics.

End-if

Else

If {Location is a new location}

Check for location anytime device is in ‘awake state’.
Note: App not permitted to wake device for location check

Else

Check for location based on heuristics.

End-if

End If

Device 10 may be operable on a plurality of power modes or settings. For example, an awake mode may include the host processor 102 being on, with the screen on. A sleep mode may include the host processor 102 being on with the screen off. A deep sleep mode may include the host processor 102 in a sleep state with the screen off. One or more of the algorithm blocks described herein may be performed only when the device is in an awake state. Other power states and settings are contemplated, such as other reduced power or reduced functionality states.

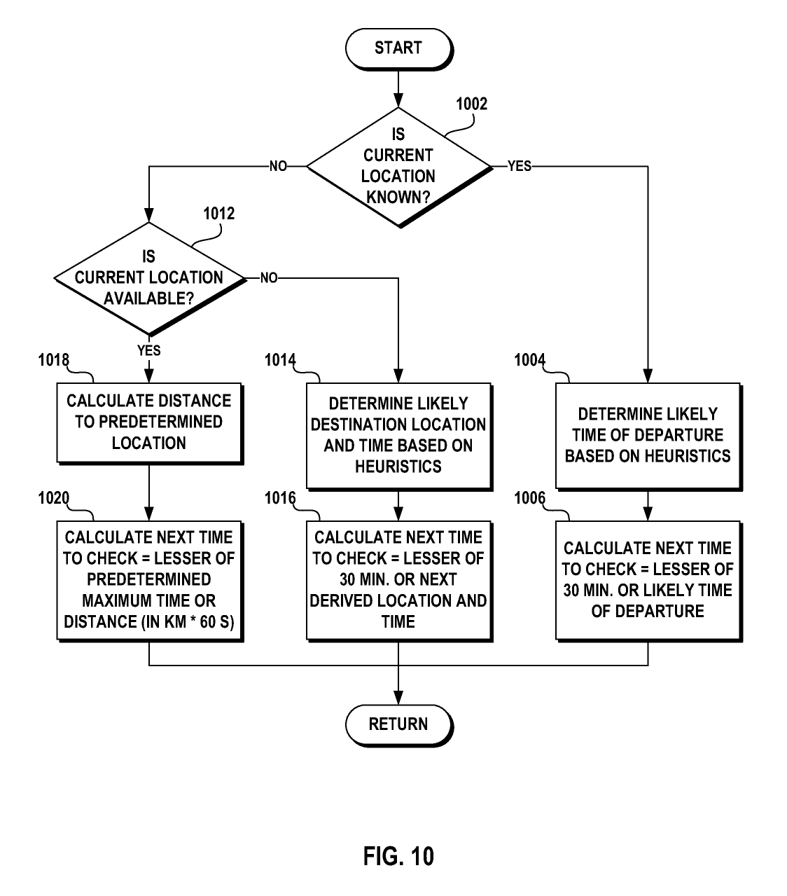

Referring now to FIG. 10, a flowchart of an operating algorithm will be described, according to an exemplary embodiment. Once device 10 has established a history for a particular user, including such data as shown in FIG. 11, an algorithm will be used to opportunistically look for location changes based on historical behavior. The device may further determine whether or not it has left a known location. An exemplary algorithm is shown below:

If {Location has changed since last check} (Loc_{current} != Loc_{old})

Determine if they have arrived at new location
Determine next time to check for location update

Else

Determine next time to check for location update.

End if

People tend to spend most of their time at specified locations (e.g., home, work, school, etc.). If the user is not at a specified location, an algorithm may be used to determine when they are likely to arrive at a specified location. FIG. 10 illustrates one example of such algorithm. At block 1002, circuit 101 determines whether the current location is known. For example, some period of time may have passed beyond which circuit 101 decides it may now know its current location. If the current location is known, at block 1004 the likely time of departure from the location is calculated based on heuristics. At a block 1006, the next time to check if the user has departed from the predetermined location is set to the lesser of a predetermined time period (e.g., 30 minutes) and the likely time of departure calculated in block 1004.

If the current location is unknown, circuit 101 then determines whether the current location is available. For example, if location determination circuit 134 can provide a location, the current location is available. If not available, at block 1014 the likely destination location and time are determined based on heuristic. At block 1016, circuit 101 calculates the next time to check as the lesser of a predetermined time (e.g., 30 minutes) or the next derived location and time from block 1014. If current location is available at block 1012, a distance to the predetermined location is calculated at block 1018. At block 1020, the next time to check is calculated, set equal to the lesser of a predetermined maximum time (e.g., one hour) or the distance calculated in block 1018 times a pre-set time, such as sixty seconds. U.S. patent application Ser. No. 12/549,249 entitled “Power Saving System and Method for Mobile Computing Device,” filed Aug. 27, 2009 to Fong et al., is incorporated by reference herein its entirety. An exemplary algorithm is shown below:

If {Location is unknown} (Loc_{current} = unknown)

If {Current Location is available} (Loc_{current} = Lat/Long)

Determine how close user is to a location
Schedule next location check for one hour, or (distance in
km)*(60sec), whichever is lower

Else

Based on heuristics, determine which location a user is likely
to go to, and when they are likely to arrive.
Schedule next location check for 30 min, or next derived
location time, Based on heuristics, whichever is lower

Else

Based on heuristics, determine when the user is likely to leave the
current location
Schedule next location check for 30 min, or next derived location
departure time, whichever is lower

End if

Periodically device 10 will wake up and perform an algorithm to establish the probability that the user will arrive/depart from a location and derive the next time that it should check for a location change. The ‘window’ represents the amount of time until the next location check. If the user is unlikely to arrive/depart, then the window will increase to reduce the power consumption. If there is an increased probability that a location change occurs, then the window will reduce so we can more accurately capture when that change has occurred. An exemplary algorithm is shown below, in which T=size of window (in seconds), t₁, t₂, t₃, . . . tₙ=timestamps for each respective instance in window where location change occurred, and n=number of instances where location change occurred:

n=count (instances between time_{current} and time_{(current+T)} where location change occurred.

If {n>0}

t_{avg} = (t₁, t₂, t₃, ... tₙ)/n
If { t_{avg} < T/2}

The user frequently leaves in the first half of the window, so
reduce the size of the window
Set T = T/2
If {T > 300 seconds}

Repeat Code Algorithm

Endif

Else

n₂ = count(instances between time_{current} and time_{(current + T/2)}

where location change occurred.

If { n₂ = 0 }

The user has never left in the first half of the window, so
leave the window at T

Else

The user typically leaves in the second half of the window,
but has left if the first half of the window, so reduce the
size of the window
Set T = T/2

End-if

End If

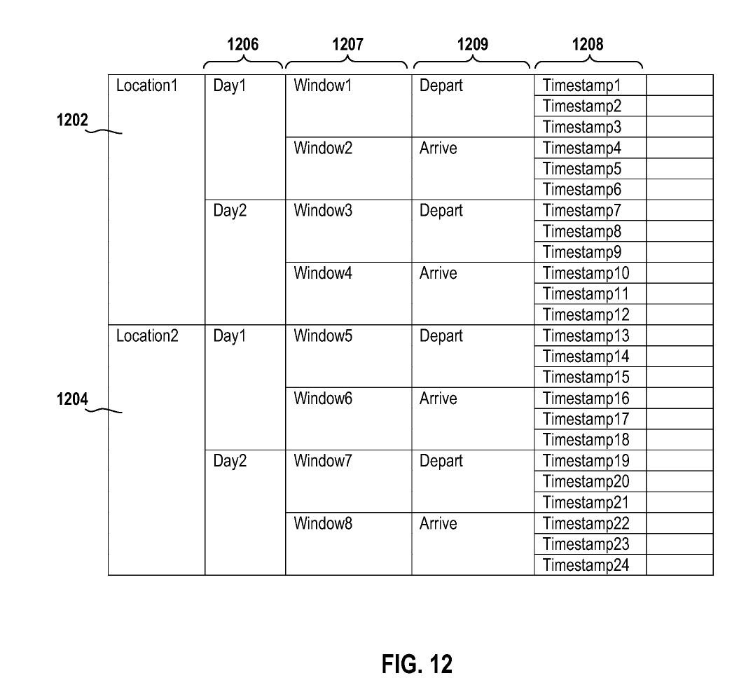

The respective timestamps may be grouped into time windows, with each time window defined by the average of the contained timestamps. To establish a window, an algorithm may be applied to define a cluster of times when an event has occurred. The windows may be limited in size to specified time, t. Another exemplary data structure may be as shown in FIG. 12. In FIG. 12, locations 1202 and 1204 each have days of the week 1206 associated with them. For each day of the week for which timestamp data is collected, the timestamps are grouped into windows 1207 for departure and arrival 1209. The timestamps are shown at element 1208.

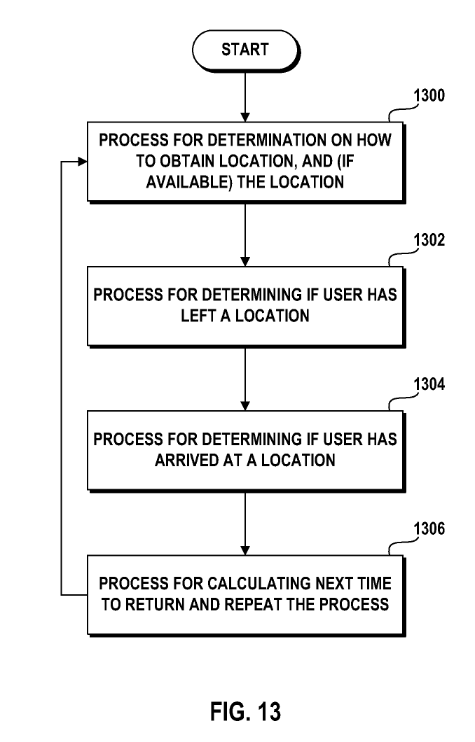

Referring now to FIG. 13, an operating algorithm according to another exemplary embodiment will be described. At block 1300, processing circuit 101 is configured to determine how location will be obtained and, if available, the current location. For example, one or more of wi-fi access points, cell IDs, GPS stand alone, GPS assist, etc. may be used to determine location. Circuit 101 may determine which one or more of these location determination techniques to use based, for example, on the availability of signals from GPS satellites, wi-fi access points, etc., the capabilities of device 10, the state of device 10 (e.g., whether an airplane mode is on), etc. At block 1302, processing circuit 101 is configured to determine whether device 10 has left a predetermined location, for example as described with reference to blocks 614, 810 and/or 914. At block 1304, processing circuit 101 is configured to determine if a user has arrived at one of the predetermined locations, for example as described with reference to blocks 614, 700, 810, and/or 914 above. At block 1306, processing circuit 101 is configured to calculate a next time to return and repeat blocks 1300 through 1306, or portions thereof, for example as described with reference to blocks 706, 806, 910, 1006, 1016 and/or 1020.

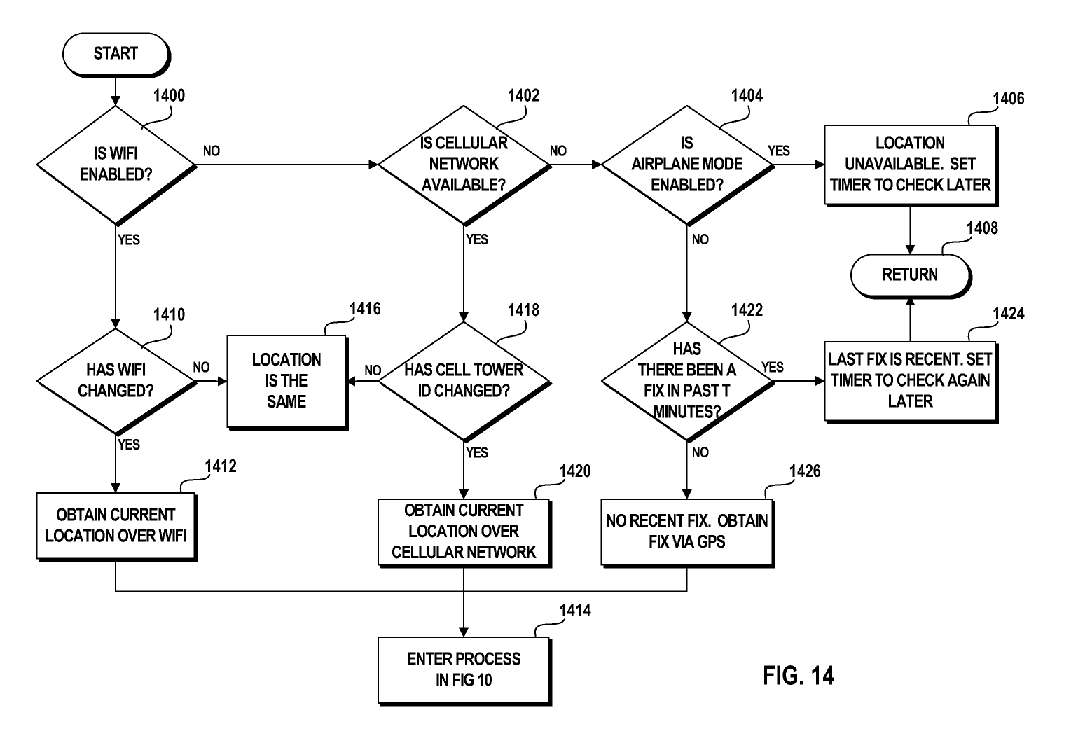

Referring now to FIG. 14, an operating algorithm according to another embodiment will be described. At block 1400, processing circuit 101 is configured to determine whether a wi-fi transceiver circuit on device 10 is enabled. If not, at block 1402, circuit 101 determines whether a cellular network signal is available. If not, and airplane mode is enabled (e.g., all wireless transceivers are disabled or put into a sleep state or non-functional state) (block 1404), circuit determines that location is unavailable and a timer is set to check again a predetermined time period later (block 1406), after which processing returns (block 1408).

At block 1400, if a wi-fi circuit is enabled, circuit 101 determines if the wi-fi access point IDs which are detected have changed. If so, at block 1412, circuit 101 obtains a current location using the wi-fi circuit. For example, circuit 101 may be configured to operate a latitude/longitude location look-up, for example using a server storing latitude/longitude data and associated wi-fi access point ideas, such as provided by Skyhook Wireless, Inc. As another example, circuit 10 may be configured to determine which wi-fi IDs are nearby for comparison to wi-fi IDs previously associated with a location of interest to determine an approximate location of device 10. As yet another example, current location may be obtained using AGPS. Processing continues at block 1002 of FIG. 10 (block 1414).

At block 1410, if wi-fi access point IDs have not changed, circuit 101 determines that the location of device 10 is the same or similar, or has not changed significantly (block 1416). Similarly, if wi-fi is not available, but a cellular network is available (block 1402), circuit 101 determines if a cell tower ID or IDs have changed (block 1418). If not, circuit 101 determines the location of device 10 is the same (block 1416). If cell tower ID has changed, a current location is obtained over the cellular network (block 1420), for example using an AGPS fix, after which processing continues at block 1002 of FIG. 10 (block 1414).

At block 1404, if wi-fi is disabled and no cellular network is available, but airplane mode is not enabled, processing circuit 101 determines whether there has been a position fix provided by the location determination circuit within the past predetermined time period (e.g., t minutes) (block 1422). If so, the last position fix is sufficiently recent, and a timer is set to check for a new position fix later (block 1424), after which processing returns at block 1408. At block 1422, if there has not been a position fix in the past t minutes, circuit 101 determines that it has no sufficiently recent position fix and it turns on or wakes up a GPS circuit on device 10 to obtain a position fix via GPS (standalone, assist, etc.) (block 1426), after which processing continues at block 1414.

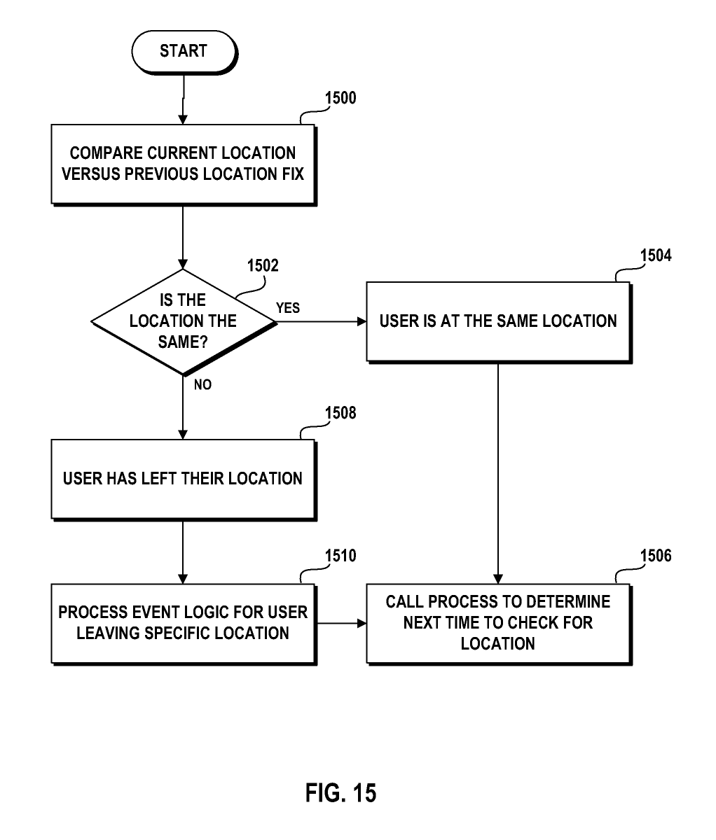

Referring now to FIG. 15, an operating algorithm according to another exemplary embodiment will be described. At block 1500, a current location (as generated by blocks 1412, 1420 or 1426) is compared with a previous location fix. At block 1502, if the two locations are sufficiently close to each other, circuit 101 determines that a user is at the same location (block 1504) and a process is called to determine the next time to check for location (block 1506). At block 1502, if the location is not the same, circuit 101 determines that the user has left the location (block 1508) and event logic for the user leaving a specific location is processed (block 1510), such as described above at blocks 700-702, 810-812, 914-915 and/or 1010. After block 1510, the process proceeds to block 1506.

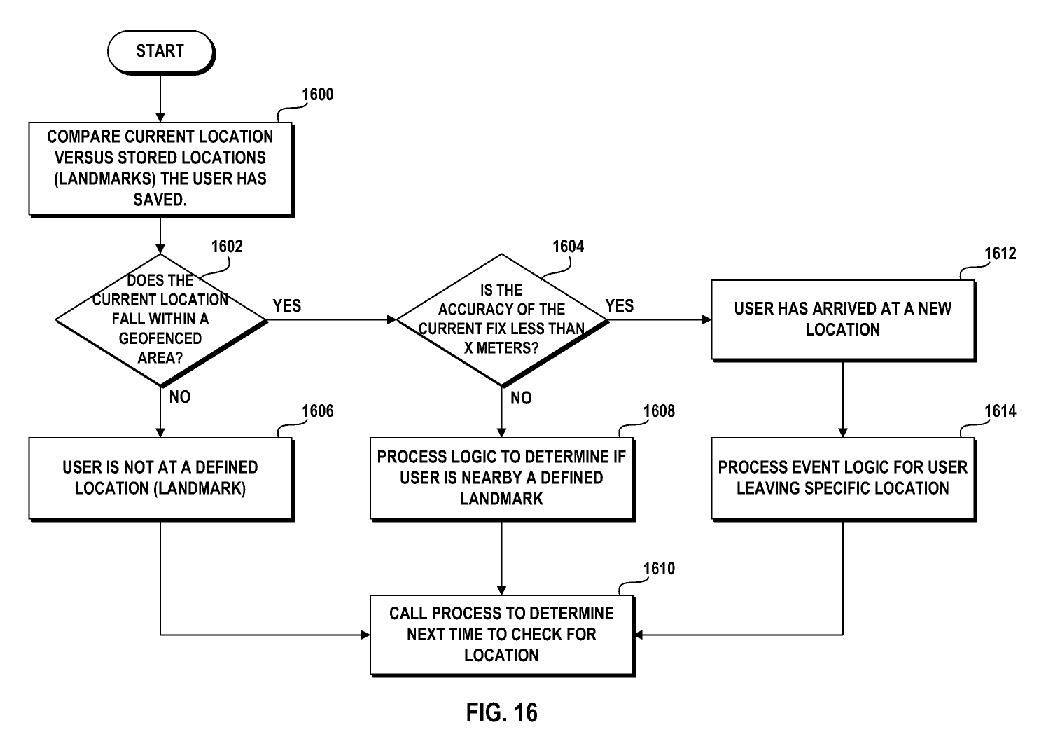

Referring now to FIG. 16, an operating algorithm according to another exemplary embodiment will be described. At block 1600, a current location is compared to one or more stored locations (e.g., landmarks, predetermined locations, etc.) which have been saved by the user or received from another source. For example, block 1600 may operate similarly to block 614, 700, 810, 914 and/or 1010. At block 1602, if the current location falls within a geofenced area (e.g., a predetermined distance from or within a range of wireless access points associated with one of the predetermined locations), processing continues at block 1604. If the current location is not within a geofenced area (block 1606) indicating the user is not at a landmark location, processing continues at block 1610, wherein processing circuit 101 calls a process to determine a next time to check for location.

At block 1604, if device 10 is within a geofenced area, processing circuit 101 determines if the accuracy of the current fix is less than a predetermined distance (e.g., x meters, which may be less than 100 m, or preferably less than 25 meters). If the accuracy is not sufficient, processing continues at block 1608 to see if the device 10 is nearby a predetermined location. If the accuracy is sufficient, processing continues at block 1612, wherein processing circuit 101 determines the user has arrived at a new location, such as one of the predetermined locations. At a block 1614, event logic is processed for a user leaving the specific location, for example as described with reference to FIG. 15, after which processing continues at block 1610.

According to some embodiments, a reduced power mode may be a standby mode, suspend mode, idle mode, hibernation mode, or other operating mode. The reduced power mode may be any mode in which some power is consumed but less power is consumed than in a normal operating mode (i.e., a mode in which typical host processor functions are operable). For example, a reduced power mode may reduce power consumption by at least about 50%, or at least about 75% or at least about 90%, or other amounts.

U.S. patent application Ser. No. 12/872,703 filed Aug. 31, 2010, entitled “Use of Wireless Access Point ID for Position Determination” to Nitin Kumar is incorporated by reference herein in its entirety.

According to one exemplary embodiment, device 10 may be programmed to not poll or track position at 3 AM. Device 10 may arise out of sleep state around 7 AM and poll or generate location data every half hour. As time gets closer to the time device 10 typically has arrived at school (8 AM), polling increases in frequency to every minute, every 5 minutes, etc. Polling or generating location data may comprise looking at Wi-Fi IDs, cellular IDs, or GPS position fixes.

Various embodiments disclosed herein may include or be implemented in connection with computer-readable media configured to store machine-executable instructions therein, and/or one or more modules, circuits, units, or other elements that may comprise analog and/or digital circuit components configured, arranged or programmed to perform one or more of the operations recited herein. For example, a processing circuit may comprise one or more circuits, integrated circuits, processors, components, etc. which may be mounted on a single board or on a plurality of circuit boards, within a single housing or in multiple housings. By way of example, computer-readable media may include RAM, ROM, CD-ROM, or other optical disk storage, magnetic disk storage, or any other non-transitory medium capable of storing and providing access to desired machine-executable instructions. Blocks in the flowcharts may be performed in any order, and one or more blocks may be omitted from various embodiments.

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the present disclosure as expressed in the appended claims.

What is claimed is:

1. A mobile computing device, comprising:
a wireless transceiver; and
a processing circuit configured to store a data set for a predetermined location, the data set comprising location data and a location name, to compare a current location to the location data, to compare an updated location to the location data at a time calculated based on heuristic data, and to generate a notification message based on the mobile computing device arriving proximate to the predetermined location.

2. The mobile computing device of claim 1, wherein the processing circuit is configured to identify the predetermined location by receiving the location data, receiving a request to store the location, and receiving an alphanumeric name for the predetermined location.

3. The mobile computing device of claim 1, wherein the location data comprises an identifier of a wireless access point.

4. The mobile computing device of claim 1, wherein the heuristic data comprises a time of day associated with the predetermined location, wherein the processing circuit is configured to generate the time of day based on a prior occurrence of the mobile computing device being present at the predetermined location.

5. The mobile computing device of claim 1, wherein the heuristic data comprises a plurality of arrival times of day and a plurality of departure times of day associated with the predetermined location.

6. The mobile computing device of claim 1, wherein the heuristic data further comprises a day of the week, wherein the processing circuit is configured to generate the day of the week based on a prior occurrence of the mobile computing device being present at the predetermined location.

7. The mobile computing device of claim 1, wherein the time to compare the updated location is based further on whether the storage of the data set for a predetermined location occurred more than a predetermined time ago.

8. The mobile computing device of claim 1, wherein the time to compare the updated location is based further on a distance from the mobile computing device to the predetermined location.

9. A method operable on a mobile computing device, comprising:
storing a data set for a predetermined location, the data set comprising location data and a location name;
comparing a current location to the location data;
calculating a subsequent time to compare an updated location to the location data, wherein the subsequent time calculation is based on historical data about the mobile computing device location; and
generating a notification message based on the mobile computing device arriving proximate to the predetermined location.

10. The method of claim 9, further comprising identifying the predetermined location by receiving the location data, receiving a request to store the location, and receiving an alphanumeric name for the predetermined location.

11. The method of claim 10, wherein the location data comprises an identifier of a wireless access point.

12. The method of claim 11, wherein the historical data comprises a time of day associated with the predetermined location, further comprising generating the time of day based on a prior occurrence of the mobile computing device being present at the predetermined location.

13. The method of claim 12, wherein the time to compare the updated location is based further on a distance from the mobile computing device to the predetermined location.

14. The method of claim 9, wherein the time to compare the updated location is based further on whether the storage of the data set for a predetermined location occurred more than a predetermined time ago.

15. The method of claim 9, wherein the heuristic data further comprises a day of the week, further comprising generating the day of the week based on a prior occurrence of the mobile computing device being present at the predetermined location.

16. A non-transitory computer-readable storage medium having stored thereon machine-readable instructions for causing, when executed, one or more machines to perform the following:
storing a data set for a predetermined location, the data set comprising location data and a location name;
comparing a current location of a mobile computing device to the location data;
calculating a subsequent time to compare an updated location to the location data, wherein the subsequent time calculation is based on pre-stored data about the mobile computing device location and time associated with the location; and
generating a notification message based on the mobile computing device arriving proximate to the predetermined location.

17. The computer-readable medium of claim 16, further comprising identifying the predetermined location by receiving the location data, receiving a request to store the location, and receiving an alphanumeric name for the predetermined location.

18. The computer-readable medium of claim 16, wherein the location data comprises an identifier of a wireless access point.

19. The computer-readable medium of claim 16, wherein the historical data comprises a time of day associated with the predetermined location, further comprising generating the time of day based on a prior occurrence of the mobile computing device being present at the predetermined location.

20. The computer-readable medium of claim 16, wherein the time to compare the updated location is based further on a distance from the mobile computing device to the predetermined location.
